(19) United States
(12) Patent Application Publication
(10) Pub. No.: US 2012/0276368 A1
(43) Pub. Date: Nov. 1, 2012

(54) Burnthrough Protection System

(76) Inventors: Joseph A. Fernando, Amherst, NY (US); Chad E. Garvey, Lewiston, NY (US); Robert Rioux, Amherst, NY (US); Kenneth B. Miller, Lockport, NY (US)

(21) Appl. No.: 13/299,384

(22) Filed: Nov. 18, 2011

Related U.S. Application Data
(60) Provisional application No. 61/480,730, filed on Apr. 29, 2011.

(51) Int. Cl. B32B 3/26

(52) U.S. Cl. 428/319.1; 428/304.4

(57) ABSTRACT

A burnthrough protection system including a fire barrier layer, a foam insulation material, and a distinct buffer layer disposed between the fire barrier layer and the foam insulation material, wherein the buffer layer is adapted to prevent adhesion between the fire barrier layer and the foam insulation at elevated temperature. The burnthrough protection system may be capable of passing the flame propagation and burnthrough resistance test protocols of 14 C.F.R. §25.856(a) and (b), Appendix F, Parts VI and VII. Also, an aircraft including an exterior skin, an interior liner, and the burnthrough protection system disposed between the exterior skin and the interior liner.

This application claims the benefit of the filing date under 35 U.S.C. 119(e) from U.S. Provisional Application For Patent Ser. No. 61/480,730 filed on Apr. 29, 2011.

A burnthrough protection system is provided for use as thermal and acoustical insulation systems, such as, but not limited to, those used in commercial aircraft.

The Federal Aviation Administration (FAA) has promulgated regulations, contained in 14 C.F.R. §25.856(a) and (b), requiring thermal and acoustical insulation blanket systems in commercial aircraft to provide improved burnthrough protection and flame propagation resistance. These conventional thermal and acoustical insulation systems typically include thermal and acoustical insulation blankets encapsulated within a film covering or bag. As the thermal and acoustical insulation systems are conventionally constructed, the burnthrough regulations primarily affect the contents of the insulation systems' bags and the flame propagation resistance regulations primarily affect the film coverings used to fabricate the bags. Conventional film coverings typically are used as a layer or covering, for example, laid over or laid behind layers of thermal and acoustical insulation material, or as a covering or bag for partially or totally encapsulating one or more layers of thermal and acoustical insulation material.

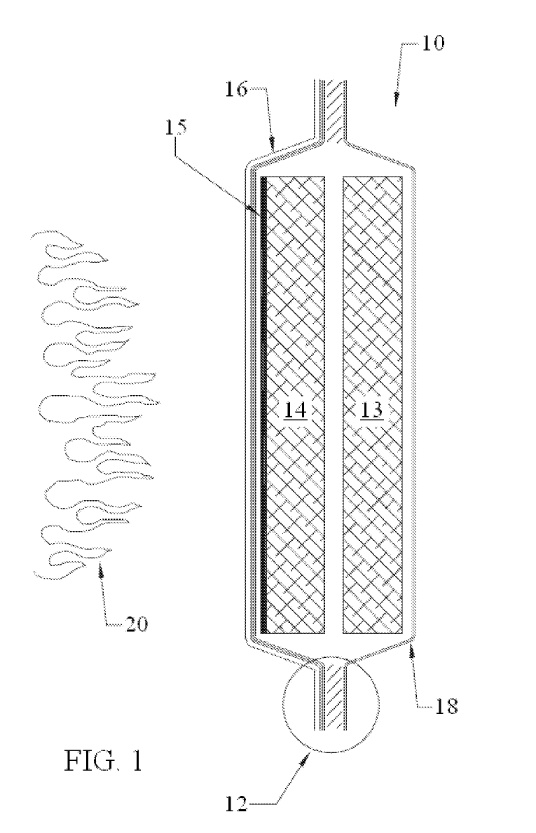

FIG. 1 is a schematic cross-sectional view of an embodiment of the subject burnthrough protection system.

A burnthrough protection system is provided which may be used as a thermal and acoustical insulation system, such as, but not limited to, those used in commercial aircraft. The burnthrough protection system comprises a fire barrier layer, a foam insulation material, and a distinct buffer layer disposed between the fire barrier layer and the foam insulation material, wherein the buffer layer is adapted to prevent adhesion between the fire barrier layer and the foam insulation at elevated temperature.

The subject burnthrough protection system solves problems previously associated with the use of conventional thermal-acoustic insulation systems which include foam insulation materials encapsulated in fire barrier layers. In these conventional systems, the foam insulation is typically in direct contact with the fire barrier layer.

Without wishing to be limited by theory, it is thought that one possible failure mode of these conventional foam insulation-based thermal-acoustic insulation systems occurs when the interface between the foam insulation material and the fire barrier layer is heated to the point where at least one of the engaged materials begin to melt. When the materials begin to melt, adhesion between the foam insulation material and the fire barrier layer may occur, causing tears or other defects in the fire barrier layer. These tears or other defects allow heat and/or flames to pass through the fire barrier layer, whereas when these same fire barrier layers are utilized in insulation systems which do not utilize foam insulation, they provide adequate protection against flame propagation and burnthrough. Other failure modes are possible, which are alleviated by the subject burnthrough protection system.

Incorporation of the present distinct buffer layer has been shown to substantially stop the foam insulation material from adhering to the fire barrier layer. Thus, the fire barrier layer is able to retain its physical integrity.

The subject burnthrough protection system provides a light basis weight insulation system with surprising resistance to damage associated with handling and use along with the ability to resist flame propagation and flame penetration as defined in 14 C.F.R. §25.856(a) and (b). The term “basis weight” is defined as the weight per unit area, typically defined in grams per square meter (gsm). The subject system is useful in providing fire burnthrough protection for thermal and acoustical insulation structures for commercial aircraft fuselages. The subject buffer layer may have a basis weight of from about 2 gsm to about 50 gsm, and in certain embodiments from about 6 gsm to about 10 gsm.

The buffer layer may comprise a non-intumescent material and/or an intumescent material, and may optionally include a binder. The buffer layer comprising an intumescent material may be capable of expanding when the buffer layer experiences a temperature of from about 200° F. (93.3° C.) to about 1,950° F. (1,066° C.). Regardless of the buffer layer's ability to expand in the presence of heat, the buffer layer will be able to prevent adhesion between the foam insulation material and the fire barrier layer when the system is exposed to heat and/or flame.

The buffer layer may comprise at least one platelet and/or non-platelet material, which material may comprise at least one of boron nitride, vermiculite, mica, graphite or talc. The platelet material may be present in the buffer layer in an amount of from about 5 weight percent to about 95 weight percent, in certain embodiments from about 40 weight percent to about 60 weight percent, based on the total weight of the buffer layer.

In embodiments in which the buffer layer comprises a platelet material, it is believed (without wishing to be limited by theory) that the individual platelets of the buffer layer interact with each other and/or with the surface with which they are in contact in order to prevent adhesion between the foam insulation material and the fire barrier layer.

The buffer layer may include inorganic binders. Without limitation, suitable inorganic binders include colloidal dispersions of alumina, silica, zirconia, and mixtures thereof. The inorganic binders, if present, may be used in amounts ranging from 0 to about 90 percent by weight, in some embodiments from 40 to about 60 weight percent, based upon the total weight of the buffer layer.

The buffer layer may further include one or more organic binders. The organic binder(s) may be provided as a solid, a liquid, a solution, a dispersion, a latex, or similar form. Examples of suitable organic binders include, but are not limited to, acrylic latex, (meth)acrylic latex, phenolic resins, copolymers of styrene and butadiene, vinylpyridine, acrylonitrile, copolymers of acrylonitrile and styrene, vinyl chloride, polyurethane, copolymers of vinyl acetate and ethylene, polyamides, organic silicones, organofunctional silanes, unsaturated polyesters, epoxy resins, polyvinyl esters (such as polyvinylacetate or polyvinylbutyrate latexes) and the like.

The organic binder, if present, may be included in the buffer layer in an amount of from 0 to about 90 weight percent, in some embodiments from 30 to about 60 weight percent, based upon the total weight of the fire barrier layer.

Solvents for the binders, if needed, can include water or a suitable organic solvent, such as acetone, for the binder utilized. Solution strength of the binder in the solvent (if used) can be determined by conventional methods based on the binder loading desired and the workability of the binder system (viscosity, solids content, etc.).

The buffer layer may additionally comprise at least one functional filler. The functional filler(s) may include, but not be limited to, clays, fumed silica, cordierite and the like. According to certain embodiments, the functional fillers may include finely divided metal oxides, which may comprise at least one of pyrogenic silicas, arc silicas, low-alkali precipitated silicas, fumed silica, silicon dioxide aerogels, aluminum oxides, titania, calcia, magnesia, potassia, or mixtures thereof.

In certain embodiments, the functional filler may comprise endothermic fillers such as alumina trihydrate, magnesium carbonate, and other hydrated inorganic materials including cements, hydrated zinc borate, calcium sulfate (gypsum), magnesium ammonium phosphate, magnesium hydroxide or combinations thereof. In further embodiments, the functional filler(s) may include lithium-containing minerals. In still further embodiments, the functional fillers(s) may include fluxing agents and/or fusing agents.

In certain embodiments, the functional filler may comprise fire retardant fillers such as antimony compounds, magnesium hydroxide, hydrated alumina compounds, borates, carbonates, bicarbonates, inorganic halides, phosphates, sulfates, organic halogens or organic phosphates. In certain embodiments, functional fillers may preserve or enhance the flame propagation resistance of the foam insulation materials.

The buffer layer is engaged with a foam insulation material, such as by coating the buffer layer onto the foam insulation or otherwise disposing a distinct buffer layer between the foam insulation and the fire barrier layer. The buffer layer may be coated onto the foam insulation material, for example, without limitation, by roll or reverse roll coating, gravure or reverse gravure coating, transfer coating, spray coating, brush coating, dip coating, tape casting, doctor blading, slot-die coating or deposition coating. In certain embodiments, the buffer layer is coated onto the foam insulation material as a slurry of the ingredients in a solvent, such as water, and is allowed to dry prior to incorporation into the burnthrough protection system. The buffer layer may be created as a single layer or coating, thus utilizing a single pass, or may be created by utilizing multiple passes, layers or coatings. By utilizing multiple passes, the potential for formation of defects in the buffer layer is reduced. If multiple passes are desired, the second and possible subsequent passes may be formed onto the first pass while the first pass is still substantially wet, i.e. prior to drying, such that the first and subsequent passes are able to form a single unitary buffer layer upon drying.

The buffer layer may be present on the foam insulation material or otherwise present in the burnthrough protection system in an amount of from about 2 gsm to about 50 gsm, in certain embodiments from about 2 gsm to about 40 gsm, in further embodiments from about 2 gsm to about 30 gsm, in still further embodiments from about 2 gsm to about 20 gsm, and in other embodiments from about 6 gsm to about 10 gsm. In embodiments in which the buffer layer comprises a platelet material, the platelet material may be present on the foam insulation material in an amount of from about 0.2 gsm to about 50 gsm, in certain embodiments from about 0.2 gsm to about 40 gsm, in further embodiments from about 0.2 gsm to about 30 gsm, in still further embodiments from about 0.2 gsm to about 20 gsm, and in other embodiments from about 0.6 gsm to about 10 gsm.

In certain embodiments, the distinct buffer layer may be a separate interleaf layer between the fire barrier layer and the foam insulation material. By interleaf, it is meant that the distinct buffer layer is prepared as a separate layer or film and engaged between the fire barrier layer and the foam insulation material.

The foam insulation material may comprise at least one of polyimide foam, melamine foam or silicone foam.

The fire barrier layer may comprise at least one fire-blocking layer comprising a paper or coating comprising a fibrous or non-fibrous material. The non-fibrous material may comprise a mineral material, such as at least one of mica or vermiculite. The mica or vermiculite may be exfoliated, and may further be defoliated. By exfoliation, it is meant that the mica or vermiculite is chemically or thermally expanded. By defoliation, it is meant that the exfoliated mica or vermiculite is processed in order to reduce the mica or vermiculite to substantially a platelet form. Suitable micas may include, without limitation, muscovite, phlogopite, biotite, lepidolite, glauconite, paragonite or zinnwaldite, and may include synthetic micas such as fluorophlogopite.

While the fire-blocking layer of the fire barrier layer and the distinct buffer layer may comprise similar materials, the materials are selected according to different desired properties. The fire-blocking layer of the fire barrier layer will comprise a material which will, at least in part, assist in providing the desired flame propagation and burnthrough resistance of the resulting burnthrough protection system. The distinct buffer layer will comprise a material which will at least partially prevent adhesion between the fire barrier layer and the foam insulation when the burnthrough protection system is exposed to elevated temperatures associated with exposure to heat and/or flame. Thus, while flame propagation resistance and burnthrough resistance are desirable properties of the buffer layer, the material selected for the buffer layer need not possess these properties.

As shown in FIG. 1, an embodiment of a burnthrough protection system 10 is depicted in cross-section, in which two insulating layers 13, 14, such as foam insulation, are disposed within a covering of an exteriorly facing fire barrier layer 16, and an interiorly facing inboard cover film 18. The insulating layer 14 has a buffer layer 15 disposed on the surface of the insulating layer 14 which is adjacent to the fire barrier layer 16. The insulating layer 13 may also have a buffer layer disposed on the surface of the insulating layer 13 which is adjacent to the inboard cover film 18.

The insulating layer 13 may alternatively comprise MICROLITE AA® Premium NR fiberglass insulation (available from Johns Manville International, Inc.), and there may be two or more insulation layers, comprising a combination of foam and fiberglass insulation layers. The exteriorly facing layer 16 and the inboard film 18 may be heat sealed with an adhesive 12 to at least partially envelop or encapsulate the insulation layers 13, 14. Flames 20 are shown proximate to the exteriorly facing fire protection layer 16.

The following examples are set forth merely to further illustrate the subject burnthrough protection system. The illustrative examples should not be construed as limiting the burnthrough protection system in any manner.

Various buffer layers were prepared with different platelet materials and additives. Coating 1 was prepared by combining 161.8 g silicone elastomer and 54.1 g expandable graphite having a nominal size of greater than about 300 μm and a carbon content greater than about 95%. Coating 2 was prepared by combining 162.4 g silicone elastomer Additive and 54 g boron nitride having a mean particle diameter of about 30 μm, a surface area of about 1 m²/g and a tapped density of about 0.6 g/cm³. Coating 3 was prepared by combining 60.9 g silanol-functional silicone resin, 26.6 g toluene, and 61.2 g boron nitride having a mean particle diameter of about 30 μm, a surface area of about 1 m²/g and a tapped density of about 0.6 g/cm³. The following examples were prepared by spraying one of Coatings 1 through 3 in an amount as shown in Table 1 onto 1″ thick polyimide foam (SOLIMIDE AC-530, Evonik-Degussa Corp.).

TABLE 1

| Example # | Coating | Coating Weight (gsm) |
|---|---|---|
| 1 | 1 | 8.7 |
| 2 | 1 | 7.0 |
| 3 | 1 | 6.1 |
| 4 | 2 | 7.4 |
| 5 | 2 | 6.9 |
| 6 | 2 | 13.2 |
| 7 | 3 | 8.1 |
| 8 | 3 | 7.3 |
| 9 | 3 | 9.5 |

The burnthrough protection system described herein may be capable of passing the flame propagation and burnthrough resistance test protocols of 14 C.F.R. §25.856(a) and (b), Appendix F, Parts VI and VII. The burnthrough protection system may be disposed between the exterior skin and the interior liner of an aircraft, such as between the exterior skin and the interior cabin liner or the interior hold liner.

### TEST PROTOCOLS

The burnthrough protection systems described above were tested according to the protocols of 14 C.F.R. §25.856(a) and (b), Appendix F, Parts VI and VII, which are incorporated herein in their entirety, as if fully written out below.

14C.F.R. §25.856(a) and (b) provide in pertinent part:

TABLE 2
§ 25.856 Thermal/Acoustic insulation materials.

(a) Thermal/acoustic insulation material installed in the fuselage must meet
the flame propagation test requirements of part VI of Appendix F to this
part, or other approved equivalent test requirements.
(b) For airplanes with a passenger capacity of 20 or greater, thermal/
acoustic insulation materials (including the means of fastening the
materials to the fuselage) installed in the lower half of the airplane
fuselage must meet the flame penetration resistance test requirements
of part VII of Appendix F to this part, or other approved equivalent test
requirements.

Appendix F Part VI provides, in pertinent part:

TABLE 3
Part VI - Test Method To Determine the Flammability and Flame
Propagation Characteristics of Thermal/Acoustic Insulation Materials
Use this test method to evaluate the flammability and flame propagation
characteristics of thermal/acoustic insulation when exposed to both a radiant
heat source and a flame.

(a) Definitions.
“Flame propagation” means the furthest distance of the propagation of visible
flame towards the far end of the test specimen, measured from the midpoint of
the ignition source flame. Measure this distance after initially applying the
ignition source and before all flame on the test specimen is extinguished. The
measurement is not a determination of burn length made after the test.
“Radiant heat source” means an electric or air propane panel.
“Thermal/acoustic insulation” means a material or system of materials used to
provide thermal and/or acoustic protection. Examples include fiberglass or
other batting material encapsulated by a film covering and foams.
“Zero point” means the point of application of the pilot burner to the test
specimen.
(b) Test apparatus.
(4) Pilot Burner. The pilot burner used to ignite the specimen must be a
Bernzomatic ™ commercial propane venturi torch with an axially symmetric
burner tip and a propane supply tube with an orifice diameter of 0.006 inches
(0.15 mm). The length of the burner tube must be 2⅞ inches (71 mm). The
propane flow must be adjusted via gas pressure through an in-line regulator to
produce a blue inner cone length of ¾ inch (19 mm). A ¾ inch (19 mm)
guide (such as a thin strip of metal) may be soldered to the top of the burner
to aid in setting the flame height. The overall flame length must be
approximately 5 inches long (127 mm). Provide a way to move the burner out
of the ignition position so that the flame is horizontal and at least 2 inches (50 mm)
above the specimen plane.
(5) Thermocouples. Install a 24 American Wire Gauge (AWG) Type K
(Chromel-Alumel) thermocouple in the test chamber for temperature
monitoring. Insert it into the chamber through a small hole drilled through the
back of the chamber. Place the thermocouple so that it extends 11 inches (279 mm)
out from the back of the chamber wall, 11½ inches (292 mm) from the
right side of the chamber wall, and is 2 inches (51 mm) below the radiant
panel. The use of other thermocouples is optional.
(6) Calorimeter. The calorimeter must be a one-inch cylindrical water-cooled,
total heat flux density, foil type Gardon Gage that has a range of 0 to 5 BTU/ft²-
second (0 to 5.7 Watts/cm²).
(c) Test specimens.
(1) Specimen preparation. Prepare and test a minimum of three test
specimens. If an oriented film cover material is used, prepare and test both the warp and
fill directions.
(2) Construction. Test specimens must include all materials used in
construction of the insulation (including batting, film, scrim, tape etc.). Cut a
piece of core material such as foam or fiberglass, and cut a piece of film cover
material (if used) large enough to cover the core material. Heat sealing is the
preferred method of preparing fiberglass samples, since they can be made
without compressing the fiberglass (“box sample”). Cover materials that are
not heat sealable may be stapled, sewn, or taped as long as the cover material
is over-cut enough to be drawn down the sides without compressing the core
material. The fastening means should be as continuous as possible along the
length of the seams. The specimen thickness must be of the same thickness as
installed in the airplane.
(3) Specimen Dimensions. To facilitate proper placement of specimens in the
sliding platform housing, cut non-rigid core materials, such as fiberglass, 12
½ inches (318 mm) wide by 23 inches (584 mm) long. Cut rigid materials,
such as foam, 11½ ± ¼ inches (292 mm ± 6 mm) wide by 23 inches
(584 mm) long in order to fit properly in the sliding platform housing and
provide a flat, exposed surface equal to the opening in the housing.
(d) Specimen conditioning. Condition the test specimens at 70 ± 5° F. (21° ±
2° C.) and 55% ± 10% relative humidity, for a minimum of 24 hours prior to
testing.
(f) Test Procedure.
(1) Ignite the pilot burner. Ensure that it is at least 2 inches (51 mm) above the
top of the platform. The burner must not contact the specimen until the test
begins.
(2) Place the test specimen in the sliding platform holder. Ensure that the test
sample surface is level with the top of the platform. At “zero” point, the
specimen surface must be 7½ inches ± ⅛ inch (191 mm ± 3) below the
radiant panel.
(3) Place the retaining/securing frame over the test specimen. It may be
necessary (due to compression) to adjust the sample (up or down) in order to
maintain the distance from the sample to the radiant panel (7½ inches ± ⅛
inch (191 mm ± 3) at “zero” position). With film/fiberglass assemblies, it is
critical to make a slit in the film cover to purge any air inside. This allows the
operator to maintain the proper test specimen position (level with the top of
the platform) and to allow ventilation of gases during testing. A longitudinal
slit, approximately 2 inches (51 mm) in length, must be centered 3 inches ± ½
inch (76 mm ± 13 mm) from the left flange of the securing frame. A utility
knife is acceptable for slitting the film cover.
(4) Immediately push the sliding platform into the chamber and close the
bottom door.
(5) Bring the pilot burner flame into contact with the center of the specimen at
the “zero” point and simultaneously start the timer. The pilot burner must be
at a 27° angle with the sample and be approximately ½ inch (12 mm) above
the sample. A stop . . . allows the operator to position the burner correctly
each time.
(6) Leave the burner in position for 15 seconds and then remove to a position
at least 2 inches (51 mm) above the specimen.
(g) Report.
(1) Identify and describe the test specimen.
(2) Report any shrinkage or melting of the test specimen.
(3) Report the flame propagation distance. If this distance is less than 2
inches, report this as a pass (no measurement required).
(4) Report the after-flame time.
(h) Requirements.
(1) There must be no flame propagation beyond 2 inches (51 mm) to the left
of the centerline of the pilot flame application.
(2) The flame time after removal of the pilot burner may not exceed 3 seconds
on any specimen.

Appendix F Part VII provides, in pertinent part:

TABLE 4
Part VII - Test Method To Determine the Burnthrough Resistance of Thermal/Acoustic
Insulation Materials
Use the following test method to evaluate the burnthrough resistance characteristics
of aircraft thermal/acoustic insulation materials when exposed to a high intensity
open flame.

(a) Definitions.
Burnthrough time means the time, in seconds, for the burner flame to
penetrate the test specimen, and/or the time required for the heat flux to reach
2.0 Btu/ft²sec (2.27 W/cm²) on the inboard side, at a distance of 12 inches
(30.5 cm) from the front surface of the insulation blanket test frame,
whichever is sooner. The burnthrough time is measured at the inboard side of
each of the insulation blanket specimens.
Insulation blanket specimen means one of two specimens positioned in either
side of the test rig, at an angle of 30° with respect to vertical.
Specimen set means two insulation blanket specimens. Both specimens must
represent the same production insulation blanket construction and materials,
proportioned to correspond to the specimen size.
(b) Apparatus.
(3) Calibration rig and equipment.
(i) Construct individual calibration rigs to incorporate a calorimeter and
thermocouple rake for the measurement of heat flux and temperature. Position
the calibration rigs to allow movement of the burner from the test rig position
to either the heat flux or temperature position with minimal difficulty.
(ii) Calorimeter. The calorimeter must be a total heat flux, foil type Gardon
Gage of an appropriate range such as 0-20 Btu/ft²-sec (0-22.7 W/cm²),
accurate to ±3% of the indicated reading. The heat flux calibration method
must be in accordance with paragraph VI(b)(7) of this appendix.
(iv) Thermocouples. Provide seven ⅛ inch (3.2 mm) ceramic packed, metal
sheathed, type K (Chromel-alumel), grounded junction thermocouples with a
nominal 24 American Wire Gauge (AWG) size conductor for calibration.
Attach the thermocouples to a steel angle bracket to form a thermocouple rake
for placement in the calibration rig during burner calibration.
(5) Backface calorimeters. Mount two total heat flux Gardon type
calorimeters behind the insulation test specimens on the back side (cold) area
of the test specimen mounting frame. Position the calorimeters along the same
plane as the burner cone centerline, at a distance of 4 inches (102 mm) from
the vertical centerline of the test frame.
(i) The calorimeters must be a total heat flux, foil type Gardon Gage of an
appropriate range such as 0-5 Btu/ft²-sec (0-5.7 W/cm²), accurate to ±3% of
the indicated reading. The heat flux calibration method must comply with
paragraph VI(b)(7) of this appendix.
(6) Instrumentation. Provide a recording potentiometer or other suitable
calibrated instrument with an appropriate range to measure and record the outputs
of the calorimeter and the thermocouples.
(7) Timing device. Provide a stopwatch or other device, accurate to ±1%, to
measure the time of application of the burner flame and burnthrough time.
(c) Test Specimens.
(1) Specimen preparation. Prepare a minimum of three specimen sets of the
same construction and configuration for testing.
(2) Insulation blanket test specimen.
(i) For batt-type materials such as fiberglass, the constructed, finished blanket
specimen assemblies must be 32 inches wide by 36 inches long (81.3 by 91.4 cm),
exclusive of heat sealed film edges.
(3) Construction. Make each of the specimens tested using the principal
components (i.e., insulation, fire barrier material if used, and moisture barrier
film) and assembly processes (representative seams and closures).
(i) Fire barrier material. If the insulation blanket is constructed with a fire
barrier material, place the fire barrier material in a manner reflective of the
installed arrangement For example, if the material will be placed on the
outboard side of the insulation material, inside the moisture film, place it the same way
in the test specimen.
(v) Conditioning. Condition the specimens at 70° ± 5° F. (21° ± 2° C.) and 55% ±
10% relative humidity for a minimum of 24 hours prior to testing.
(f) Test procedure.
(1) Secure the two insulation blanket test specimens to the test frame. The
insulation blankets should be attached to the test rig center vertical former
using four spring clamps . . . (according to the criteria of paragraph (c)(4) or
(c)(4)(i) of this part of this appendix).
(2) Ensure that the vertical plane of the burner cone is at a distance of 4 ±
0.125 inch (102 ± 3 mm) from the outer surface of the horizontal stringers of
the test specimen frame, and that the burner and test frame are both situated at
a 30° angle with respect to vertical.
(3) When ready to begin the test, direct the burner away from the test position
to the warm-up position so that the flame will not impinge on the specimens
prematurely. Turn on and light the burner and allow it to stabilize for 2
minutes.
(4) To begin the test, rotate the burner into the test position and
simultaneously start the timing device.
(5) Expose the test specimens to the burner flame for 4 minutes and then turn
off the burner. Immediately rotate the burner out of the test position.
(6) Determine (where applicable) the burnthrough time, or the point at which
the heat flux exceeds 2.0 Btu/ft²-sec (2.27 W/cm²).
(g) Report.
(1) Identify and describe the specimen being tested.
(2) Report the number of insulation blanket specimens tested.
(3) Report the burnthrough time (if any), and the maximum heat flux on the
back face of the insulation blanket test specimen, and the time at which the
maximum occurred.
(h) Requirements.
(1) Each of the two insulation blanket test specimens must not allow fire or
flame penetration in less than 4 minutes.
(2) Each of the two insulation blanket test specimens must not allow more
than 2.0 Btu/ft²-sec (2.27 W/cm²) on the cold side of the insulation specimens
at a point 12 inches (30.5 cm) from the face of the test rig.

In a first embodiment, a subject burnthrough protection system may comprise a fire barrier layer, a foam insulation material, and a distinct buffer layer disposed between the fire barrier layer and the foam insulation material, wherein the buffer layer is adapted to prevent adhesion between the fire barrier layer and the foam insulation at elevated temperature.

The burnthrough protection system of the first embodiment may further include that the buffer layer comprises a non-intumescent material and optionally a binder.

The burnthrough protection system of the first embodiment may further include that the buffer layer comprises an intumescent material and optionally a binder. The buffer layer may be capable of expanding when the buffer layer experiences a temperature of from about 200° F. to about 1,950° F.

The burnthrough protection system of any of the first or subsequent embodiments may further include that the buffer layer comprises at least one of boron nitride, vermiculite, mica, graphite or talc. The buffer layer further may comprise at least one functional filler.

The burnthrough protection system of any of the first or subsequent embodiments may further include that the buffer layer is engaged with the foam insulation material.

The burnthrough protection system of any of the first or subsequent embodiments may further include that the buffer layer is coated onto the foam insulation material. The buffer layer may be present on the foam insulation material in an amount of from about 2 gsm to about 50 gsm. The buffer layer may comprise a platelet material, wherein the platelet material is present on the foam insulation material in an amount of from about 0.2 gsm to about 50 gsm.

The burnthrough protection system of any of the first or subsequent embodiments may further include that the distinct buffer layer is a separate interleaf layer between the fire barrier layer and the foam insulation material.

The burnthrough protection system of any of the first or subsequent embodiments may further include that the buffer layer comprises from about 5 weight percent to about 95 weight percent of a platelet material, in certain embodiments, from about 40 weight percent to about 60 weight percent of the platelet material. The platelet material may comprise at least one of boron nitride, vermiculite, mica, graphite or talc.

The burnthrough protection system of any of the first or subsequent embodiments may further include that the foam insulation comprises at least one of polyimide foam, melamine foam or silicone foam.

The burnthrough protection system of any of the first or subsequent embodiments may further include that the fire barrier layer comprises at least one fire-blocking layer comprising a paper or coating comprising a fibrous or non-fibrous material, optionally wherein the non-fibrous material comprises a mineral material. The mineral material may comprise at least one of mica or vermiculite. The mica or vermiculite may be exfoliated and defoliated.

The burnthrough protection system of any of the first or subsequent embodiments may further be capable of passing the flame propagation and burnthrough resistance test protocols of 14 C.F.R. §25.856(a) and (b), Appendix F, Parts VI and VII.

In a second embodiment, a subject aircraft may comprise an exterior skin, an interior liner, and the burnthrough protection system of any of the first or subsequent embodiments disposed between the exterior skin and the interior liner.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. A burnthrough protection system comprising a fire barrier layer, a foam insulation material, and a distinct buffer layer disposed between the fire barrier layer and the foam insulation material, wherein the buffer layer is adapted to prevent adhesion between the fire barrier layer and the foam insulation at elevated temperature.

2. The burnthrough protection system of claim 1, wherein the buffer layer comprises a non-intumescent material and optionally a binder.

3. The burnthrough protection system of claim 1, wherein the buffer layer comprises an intumescent material and optionally a binder.

4. The burnthrough protection system of claim 3, wherein the buffer layer is capable of expanding when the buffer layer experiences a temperature of from about 200° F. to about 1,950° F.

5. The burnthrough protection system of claim 1, wherein the buffer layer comprises at least one of boron nitride, vermiculite, mica, graphite or talc.

6. The burnthrough protection system of claim 5, wherein the buffer layer further comprises at least one functional filler.

7. The burnthrough protection system of claim 1, wherein the buffer layer is engaged with the foam insulation material.

8. The burnthrough protection system of claim 7, wherein the buffer layer is coated onto the foam insulation material.

9. The burnthrough protection system of claim 8, wherein the buffer layer is present on the foam insulation material in an amount of from about 2 gsm to about 50 gsm.

10. The burnthrough protection system of claim 8, wherein the buffer layer comprises a platelet material, wherein the platelet material is present on the foam insulation material in an amount of from about 0.2 gsm to about 50 gsm.

11. The burnthrough protection system of claim 1, wherein the distinct buffer layer is a separate interleaf layer between the fire barrier layer and the foam insulation material.

12. The burnthrough protection system of claim 1, wherein the buffer layer comprises from about 5 weight percent to about 95 weight percent of a platelet material.

13. The burnthrough protection system of claim 12, wherein the buffer layer comprises from about 40 weight percent to about 60 weight percent of the platelet material.

14. The burnthrough protection system of claim 12, wherein the platelet material comprises at least one of boron nitride, vermiculite, mica, graphite or talc.

15. The burnthrough protection system of claim 1, wherein the foam insulation comprises at least one of polyimide foam, melamine foam or silicone foam.

16. The burnthrough protection system of claim 1, wherein the fire barrier layer comprises at least one fire-blocking layer comprising a paper or coating comprising a fibrous or non-fibrous material, optionally wherein the non-fibrous material comprises a mineral material.

17. The burnthrough protection system of claim 16, wherein the mineral material comprises at least one of mica or vermiculite.

18. The burnthrough protection system of claim 17, wherein the mica or vermiculite is exfoliated and defoliated.

19. The burnthrough protection system of claim 1 capable of passing the flame propagation and burnthrough resistance test protocols of 14 C.F.R. §25.856(a) and (b), Appendix F, Parts VI and VII.

20. An aircraft comprising an exterior skin, an interior liner, and the burnthrough protection system of claim 1 disposed between the exterior skin and the interior liner.
